(19) United States
(12) Patent Application Publication
(10) Pub. No.: US 2007/0124728 A1
(43) Pub. Date: May 31, 2007

(54) Passing work between threads

(76) Inventors: Mark Rosenbluth, Uxbridge, MA (US); Myles Wilde, Charlestown, MA (US); Jon Krueger, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/288,819

(22) Filed: Nov. 28, 2005

(51) Int. Cl. G06F 9/46

(52) U.S. Cl. 718/100

(57) ABSTRACT

In general, in one aspect, the disclosure describes passing work, such as a packet, between threads of a multi-threaded system.

### REFERENCE TO RELATED APPLICATIONS

This relates to a U.S. patent application filed on Jul. 25, 2005 entitled “LOCK SEQUENCING” having attorney docket number P20746 and naming Mark Rosenbluth, Gilbert Wolrich, and Sanjeev Jain as inventors.

This relates to a U.S. patent application filed on Jul. 25, 2005 entitled “INTER-THREAD COMMUNICATION OF LOCK PROTECTED DATA” having attorney docket number P22241 and naming Mark Rosenbluth, Gilbert Wolrich, and Sanjeev Jain as inventors.

### BACKGROUND

Some processors or multi-processor systems provide multiple threads of program execution. For example, Intel's IXP (Internet eXchange Processor) network processors feature multiple multi-threaded processor cores where each individual core provided hardware support for multiple threads. The cores can quickly switch between threads, for example, to hide high latency operations such as memory accesses.

Often the threads in a multi-thread threaded system vie for access to shared resources. For example, network processor threads typically process different network packets. Some of these packets belong to the same packet flow, for example, between two network end-points. Often, a flow has associated state data that monitors the flow such as the number of packets or bytes sent through the flow. This data is often read, updated, and re-written for each packet in the flow. Potentially, however, packets belonging to the same flow may be assigned for processing by different threads at the same time. In this case, the threads will vie for access to the flow's associated state data. Often, one thread is forced to wait idly for another thread to release its control of the flow's state data before continuing its processing of a packet.

### BRIEF DESCRIPTION OF THE DRAWINGS

FIG. 1 is a diagram illustrating critical section execution by different threads.

FIGS. 2A-2B are diagrams illustrating working passing between threads.

FIGS. 3A-3E are diagrams illustrating passing of packets belonging to the same flow between threads.

FIG. 4 is a diagram of a flow-chart illustrating operation of a thread in an inter-thread work passing scheme.

FIGS. 5 and 6 are diagrams of a flow-chart illustrating operation of a lock manager in an inter-thread work passing scheme.

FIG. 7 is a diagram of a multi-core processor.

FIG. 8 is a diagram of a device to manage locks.

FIG. 9A is a diagram of logic to allocate sequence numbers.

FIG. 9B is a diagram of logic to reorder sequenced lock requests.

FIG. 9C is a diagram of logic to queue lock requests.

FIG. 10 is a diagram of circuitry to implement the logic of FIGS. 9B and 9C.

FIGS. 11A-11C are diagrams illustrating data passing between threads accessing a lock.

FIG. 12 is a flow-chart illustrating data passing between threads accessing a lock.

FIG. 13 is a diagram of a network processor having multiple programmable units.

FIG. 14 is a diagram of a lock manager integrated within the network processor.

FIG. 15 is a diagram of a programmable unit.

FIG. 16 is a listing of source code using a lock.

FIG. 17 is a diagram of a network forwarding device.

### DETAILED DESCRIPTION

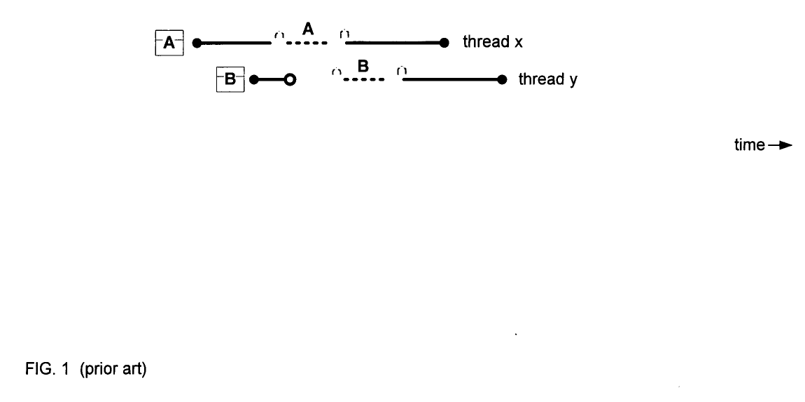

In multi-threaded architectures, threads often vie for access to shared resources. For example, FIG. 1 depicts a scheme where different threads (x and y) process different packets (A and B). For instance, each thread may determine how to forward a given packet further towards its network destination. Potentially, these different packets may belong to the same flow. For example, the packets may share the same source/destination pair, be part of the same TCP (Transmission Control Protocol) connection, or the same Asynchronous Transfer Mode (ATM) circuit. Typically, a given flow has associated state data that is updated for each packet.

As shown in FIG. 1, to coordinate access to the shared data, the threads can use a lock (depicted as a padlock). The lock provides a mutual exclusion mechanism that ensures only a single thread owns a lock at a time. Thus, a thread that has acquired a lock can perform operations with the assurance that no other thread has acquired the lock at the same time. A typical use of a lock is to create a “critical section” of instructions—thread program code that is only executed by one thread at a time (shown as a dashed line in FIG. 1). Entry into a critical section is often controlled by a “wait” or “enter” routine that only permits subsequent instructions to be executed after acquiring a lock. For example, after being granted a lock, a thread's critical section may read, modify, and write-back flow data for a packet's flow. Thus, as shown in FIG. 1, thread x acquires the lock, executes lock protected code for packet A (e.g., modifies flow data), and releases the lock. After thread x releases the lock, waiting thread y can acquire the lock, execute the protected code for packet B, and release the lock.

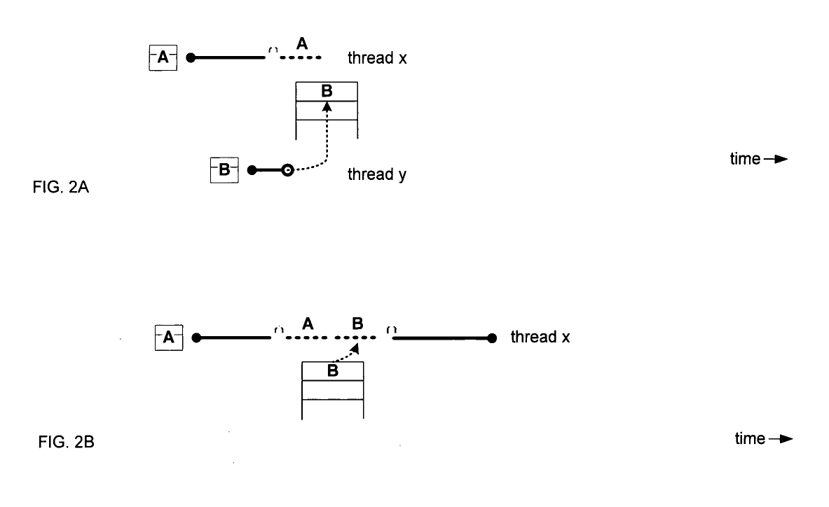

The locking scheme illustrated in FIG. 1 ensured exclusive access to the shared flow data by threads x and y. This exclusive access, however, came at the expense of thread y waiting idly until thread x released the lock. FIGS. 2A and 2B illustrate a scheme where, instead of waiting for exclusive access to a shared resource such as the flow data, a thread can, instead, pass a packet to the thread which currently owns the lock, freeing the passing thread to do other work. The thread receiving the passed work, in turn, has the option of doing the additional work itself, or notifying another thread that additional work is to be done.

To illustrate, as shown in FIG. 2A, thread x acquires a lock to the shared flow data associated with packet A. As in FIG. 1, thread y attempts to acquire (labeled as an empty circle) the lock to process packet B. However, after initially failing to obtain the lock, instead of waiting for thread x to complete its critical section execution for packet A and release the lock, thread y passes (e.g., enqueues) packet B to be processed by thread x. While thread y can go on to perform other work (e.g., process a different packet), thread x can process packet B (as shown in FIG. 2B) while thread x still owns the shared flow data. The scheme illustrated in FIGS. 2A and 2B amortizes the overhead associated with using a shared resource (e.g., obtaining a lock and reading and writing the flow state from memory) over several packets. That is, thread x can process both packets A and B while only acquiring the lock for the flow state data once, reading the flow state data from external memory once, and writing the flow state data from external memory once. Thus, in addition to potentially reducing memory operations (e.g., enqueuing packet B uses fewer memory operations than reading and writing the shared flow state data), the scheme can potentially reduce the number of lock operations associated with a given shared resource.

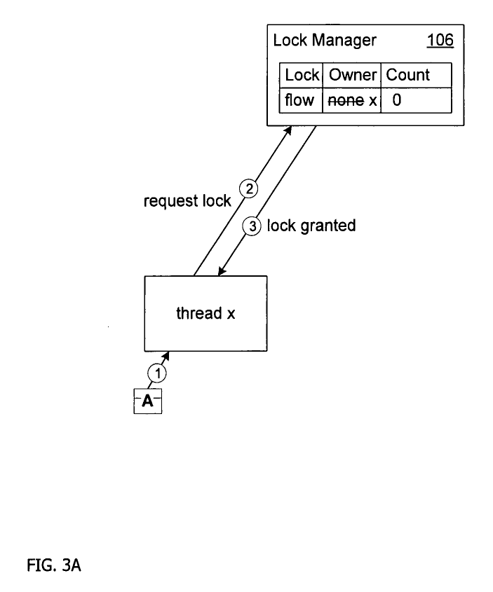

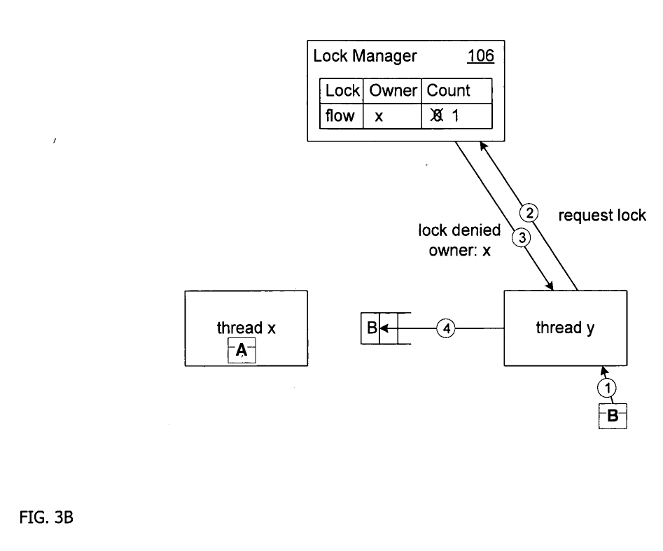

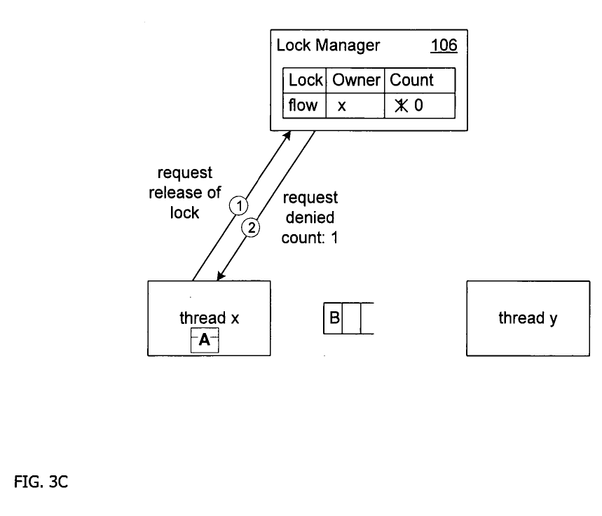

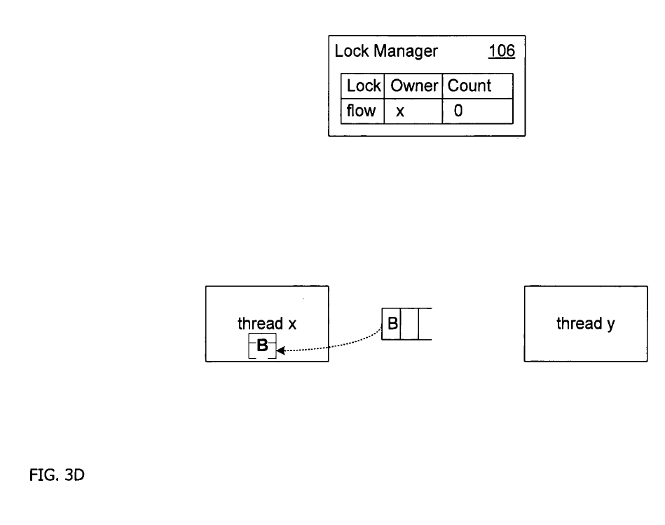

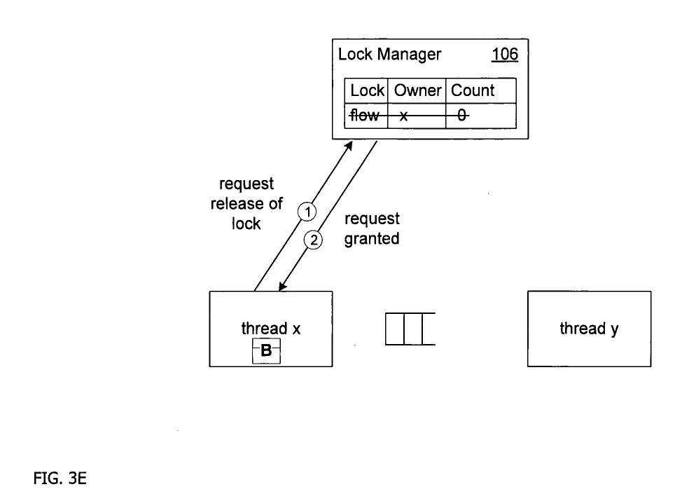

The work passing scheme illustrated in FIGS. 2A and 2B can be implemented in a wide variety of ways. For example, FIGS. 3A-3E illustrate operation of a sample implementation that features a lock manager 106 that services lock requests from threads. By handling locking operations for the different threads, the lock manager 106 acts as a central agent that can track the different requested lock operations of the different threads and share this information, for example, by notifying a thread of a current lock owner or indicating whether or how many lock requests have arrived while a lock was in use.

In the sample operation shown in FIG. 3A, in response to an assignment (1) to process packet A, thread x can request a lock (2), for example, associated with the packet flow's state data or a packet processing critical section. Assuming the lock is not currently owned by another thread, the lock manager 106 grants (3) the lock to thread x and stores data identifying ownership of the lock to thread x. As shown, the lock manager 106 can update ownership for this lock from “none” to thread x. In other implementations, however, the lock manager 106 may need to allocate a new entry for the lock.

As shown in FIG. 3B, when thread y is assigned (1) packet B belonging to the same flow as packet A, thread y requests (2) the lock to the flow state data previously granted to thread x. Since thread x still owns the lock, the lock manager 106 both denies (3) the lock to thread y and notifies thread y that the current owner is thread x. Identification of the lock owning thread, enables thread y to pass the packet for processing to thread x, for example, by way of a queue associated with thread x. In addition, the lock manager 106 increments a count of threads requesting the lock.

As shown in FIG. 3C, thread x can determine whether additional packets belonging to the flow have been enqueued for processing by thread x by other threads. For example, as shown, after completing processing of packet A, thread x issues a request (1) to release the lock. Based on the count, the lock manager (2) may deny the release request and notify thread x of the count. In other words, until the count remains unchanged between different release requests for the lock or between an owning thread's lock request and its first release request, the lock manager 106 can alert a thread to the possibility that work may have been passed to the thread for processing. In this particular example, the count of “1” represents thread y's attempt to acquire the lock and packet B being enqueued for thread x processing by thread y. The lock manager 106 may reset the count after denying thread x's lock release request. Alternately, thread x can store a copy of the count and make a comparison of the stored copy with a newly received count value to determine if additional lock requests had been received.

As shown in FIG. 3D, based on the count, thread x can dequeue the reference to packet B enqueued by thread x for packet processing. More generally, thread x can dequeue count-number of packets. Finally, in FIG. 3E, after completing processing of packet B, thread x again requests release of the lock (1). In this instance, the count of zero indicates that no other thread requested access to the lock while thread x completed processing of the enqueued packet B. Thus, the lock manager grants (2) the release request and then can free the lock for availability to other threads. In this example, thread y enqueued a single packet for processing by thread x. In another case, however, thread y and other threads may enqueue multiple packets. In some implementations, this will be directly reflected by the count. In other implementations, the lock manager 106 may merely store a “pending” bit indicating that at least one thread has requested the lock and rely on the receiving thread to correctly dequeue the right number of enqueued items.

The sample operation depicted in FIGS. 3A-3E illustrated several implementation features. For example, as shown in FIGS. 3A and 3B, the threads both issued non-blocking lock requests. That is, instead of a issuing a lock request and suspending program execution until the requested lock is granted, a thread receives an indication from the lock manager 106 indicating grant or denial of the lock. In the case of a lock grant, a program thread may then enter a critical section associated with the lock; otherwise the thread may use the work passing mechanism described above.

Additionally, the lock manager 106 stored identification of the thread currently owning a lock and communicated the identification to requesting thread y. This mechanism permits threads to identify the thread to which they should pass work.

In addition to tracking the current lock owner, the lock manager 106 also tracked denied lock requests and used the count to determine whether or not to grant a lock release request. By acting as a central repository for lock information, the lock manager can prevent a race condition from occurring that causes work passed between threads to be delayed or lost. That is, absent such a mechanism, thread y may pass work to thread x at the same time (or nearly the same time) that thread x is exiting the critical section. Work passing occurring during this small window of time may be lost since thread y assumes that thread x will handle the work, while thread x has since exited the critical section and continued other processing. By waiting for the lock manager to acknowledge/grant the lock release instead of issuing a lock release and immediately resuming processing, thread x can re-check the work passing queue after each lock release denial to ensure that no passed work (e.g., a packet) fails to be timely processed.

The operations illustrated in FIGS. 3A-3E are merely an example and many varying implementations are possible. For example, the information included in the different lock request, release, and lock manager responses could vary in different implementations. For instance, instead of including the count in the lock manager's response to a lock release request, the count could be included in a separate message. Similarly, the denial of a lock request may not include identification of the current thread owning the lock. Instead such information may be delivered by a different message or different message exchange. Additionally, though the lock manager is described above as providing a non-blocking lock (i.e., a lock that is explicitly granted or denied by the lock manager), a thread could instead use a time-out value and determine that failure to receive a grant within the time period is an implicit denial of a requested lock. Further, while FIGS. 3A-3E showed a work passing scheme that featured a work passing queue associated with each thread, other work passing messaging or queuing schemes may be used.

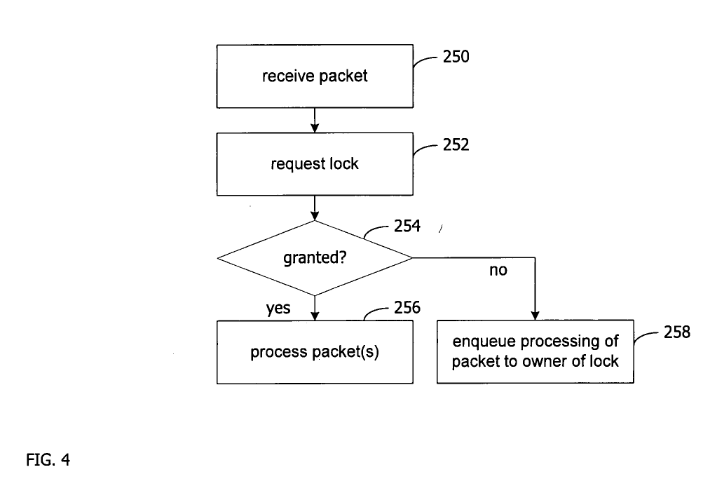

FIG. 4 is a flow-chart illustrating operation of a sample thread implementing the scheme described above. As shown, after receiving 250 identification of a network packet (e.g., a pointer to memory of a packet header or packet), the thread issues 252 a request for a lock associated with a shared resource (e.g., the packet's flow data and/or a packet processing critical section). If the lock is not granted 254, the thread can pass processing 258 of the packet to the thread currently owning the lock. If the lock is granted 254, the thread can process 256 the packet and other packets passed to the thread by other threads (e.g., those threads denied the lock 254).

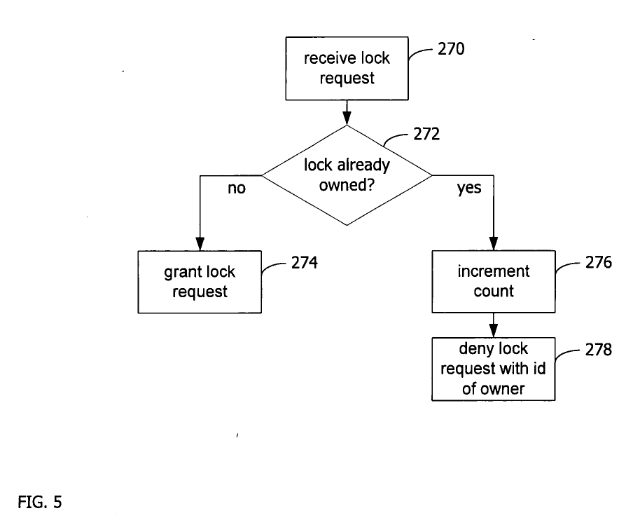

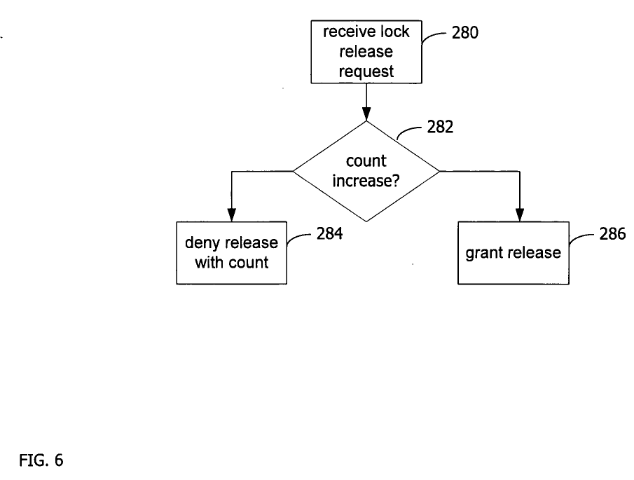

FIGS. 5 and 6 illustrate operation of a sample lock manager. As shown in FIG. 5, in response to receiving a lock request 270, the lock manager can determine 272 if the lock is currently owned by another thread. If not, the lock manager can grant 274 the lock to the requesting thread. Otherwise, the lock manager can increment 276 the count of threads that have requested the owned lock and can both deny 278 the request and notify the requesting thread of the lock owner's identity.

As shown in FIG. 6, in response to a lock release request 280 received from the thread owning the lock, the lock manager can send either a release denied 284 or release granted 286 message based on the count 282. For example, if the count is reset after each release request, a count of zero indicates that no lock requests were received since the last release request or since the initial lock acquisition. The lock manager can include the count value in the message returned to the requesting thread. Potentially, the count may represent a grant or failure (e.g., a count of zero indicates success). Alternately, the count need not be directly communicated to the thread attempting the release.

While FIGS. 2-6 described a specific application of an inter-thread work passing technique, the technique has wider applicability beyond the particular packet processing application described. The work passing technique may be used in many different applications to enable peer threads (e.g., threads programmed to perform the same processing operations on a work item such as a packet or string) to pass work amongst themselves. For example, such a technique can be used to load balance work items among peer threads.

Additionally, while the sample implementation described above features a lock manager, passing work between threads need not use the particular lock manager described herein or use a central load-monitoring agent at all. For example, the different threads may pass work based on its work queue depth, CPU idle time, or other metrics. Each thread may monitor the load of itself or other threads to determine when to pass work and where to pass it. For example, if a thread's work queue depth exceeds a threshold (e.g., an average work queue depth across peer threads), the thread may pass all the work items associated with a given work flow to another, preferably less utilized thread. Again, such a scheme may be implemented in a centralized (e.g., a centralized agent monitors the work load of the threads) or distributed manner (e.g., where a thread can independently determine whether or not to pass work).

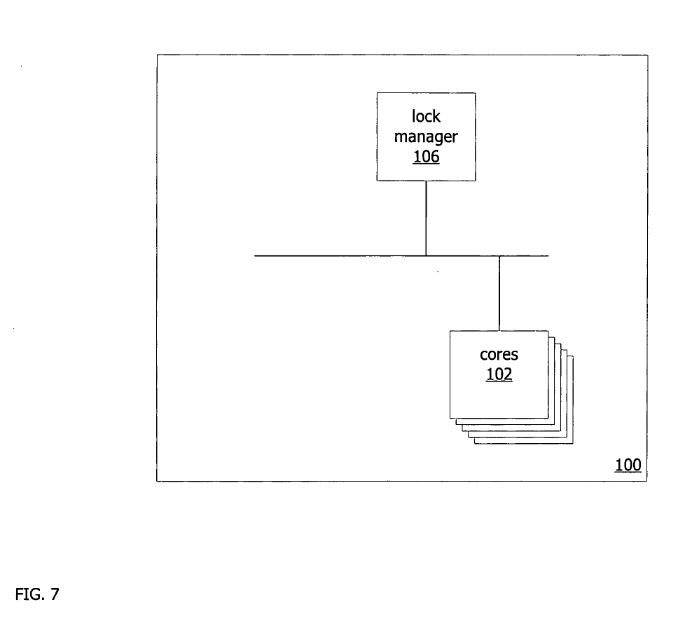

While work passing does not require a lock manager as described above, FIGS. 7-12 illustrate a sample implementation of a lock manager in greater detail. As shown in FIG. 7, the lock manager 106 may be integrated into a processor 100 that features multiple programmable cores 102 integrated on a single integrated die. The multiple cores 102 may be multi-threaded. For example, the cores may feature storage for multiple program counters and thread contexts. Potentially, the cores 102 may feature thread-swapping hardware support. Such cores 102 may use pre-emptive multi-threading (e.g., threads are automatically swapped at regular intervals), swap after execution of particular instructions (e.g., after a memory reference), or the core may rely on threads to explicitly relinquish execution (e.g. via a special instruction).

As shown, the processor 100 includes a lock manager 106 that provides dedicated hardware locking support to the cores 102. The manager 106 can provide a variety of locking services such as allocating a sequence number in a given sequence domain to a requesting core/core thread, reordering and granting locks requests based on constructed locking sequences, and granting locks based on the order of requests. In addition, the manager 106 can speed critical section execution by optionally initiating delivery of shared data (e.g., lock protected flow data) to the core/thread requesting a lock. That is, instead of a thread finally receiving a lock grant only to then initiate and wait for completion of a memory read to access lock protected data, the lock manager 106 can issue a memory read on the thread's behalf and identify the requesting core/thread as the data's destination. This can reduce the amount of time a thread spends in a critical section and, consequently, the amount of time a lock is denied to other hreads.

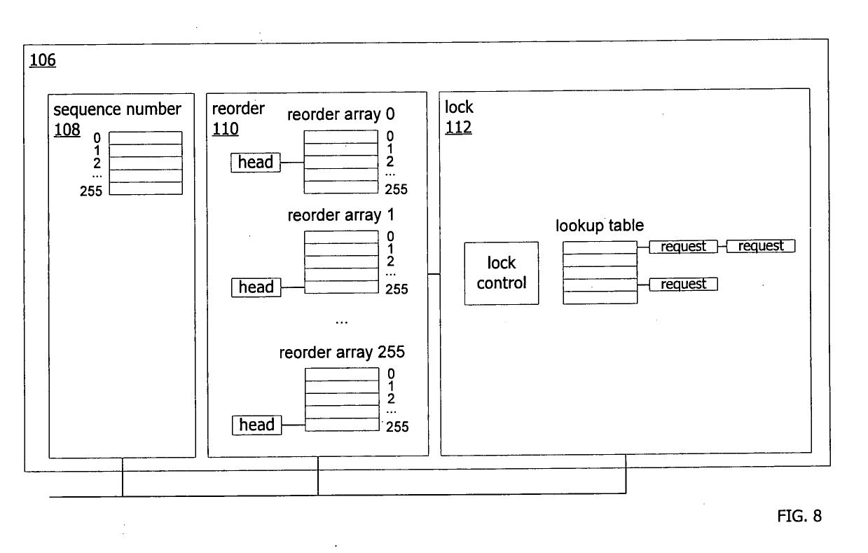

FIG. 8 illustrates logic of a sample lock manager 106. The lock manager 106 shown includes logic to grant sequence numbers 108, service requests in an order corresponding to the granted sequence numbers 110, and queue and grant 112 lock requests. Operation of these blocks is described in greater detail below.

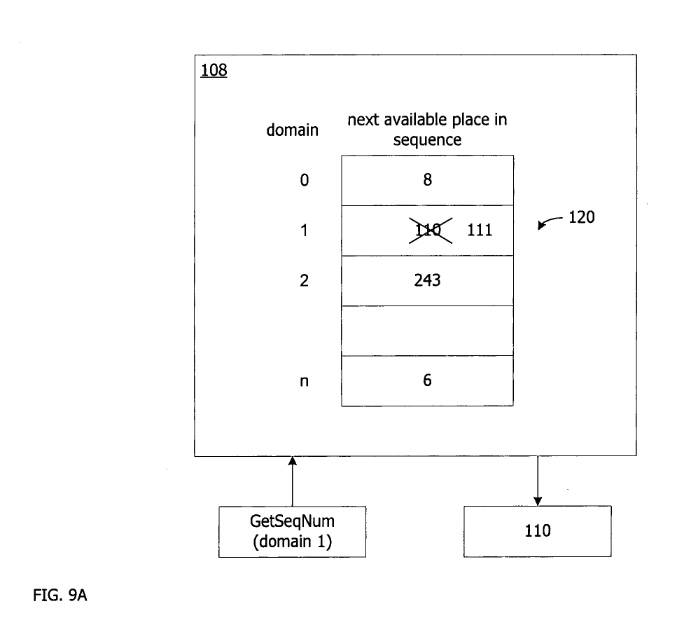

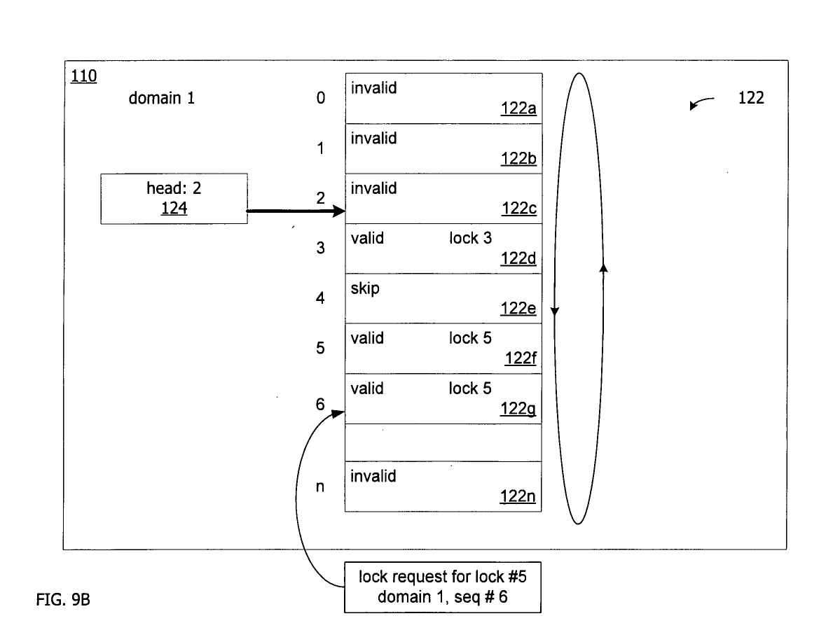

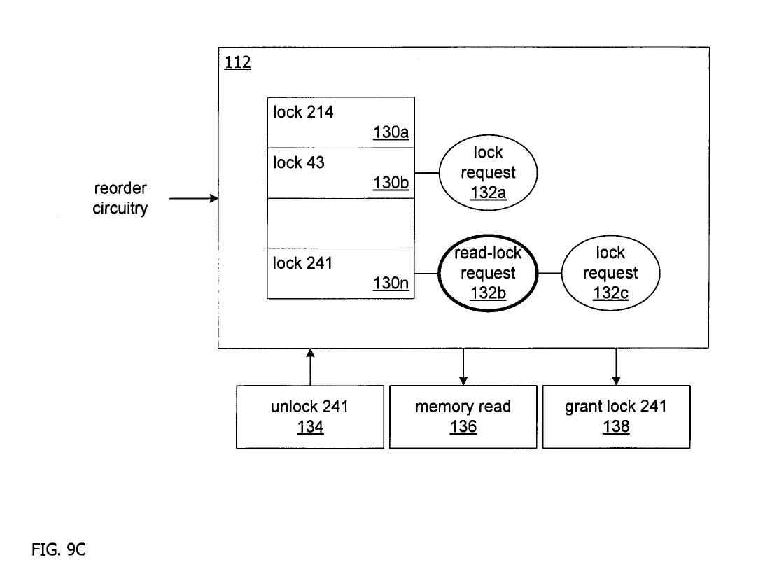

FIG. 9A depicts logic 108 to allocate and issue sequence numbers to requesting threads. As shown, the logic 108 accesses a sequence number table 120 having n entries (e.g., n=256). Each entry in the sequence number table 120 corresponds to a different sequence domain and identifies the next available sequence number. For example, the next sequence number for domain “2” is “243”. Upon receipt of a request from a thread for a sequence number in a particular sequence domain, the sequence number logic 108 performs a lookup into the table 120 to generate a reply identifying the sequence number allocated to the requesting core/thread. To speed such a lookup, the request's sequence domain may be used as an index into table 120. For example, as shown, the request for a sequence number in domain “1” results in a reply identifying entry 1's “110” as the next available sequence number. The logic 108 then increments the sequence number stored in the table 120 for that domain. For example, after identifying “110” as the next sequence number for domain “1”, the next sequence number for domain number is incremented to “111”. The sequence numbers have a maximum value and wrap around to zero after exceeding this value. Potentially, a given request may request multiple (e.g., four) sequence numbers at a time. These numbers may be identified in the same reply.

After receiving a sequence number, a thread can continue with packet processing operations until eventually submitting the sequence number in a lock request. A lock request is initially handled by reorder circuitry 110 as shown in FIG. 9B. The reorder circuitry 110 queues lock requests based on their place in a given sequence domain and passes the lock request to the lock circuitry 112 when the request reaches the head of the established sequence. For lock requests that do not specify a sequence number, the reorder circuitry 110 passes the requests immediately to the lock circuitry 112 (shown in FIG. 9C).

For lock requests participating in the sequencing scheme, the reorder circuitry 110 can queue out-of-order requests using a set of reorder arrays, one for each sequence domain. FIG. 9B shows a single one of these arrays 122 for domain “1”. The size of a reorder array may vary. For example, each domain may feature a number of entries equal to the number of threads provided (e.g., # cores x # threads/core). This enables each thread in the system to reserve a sequence number in the same array. However, an array may have more or fewer entries.

As shown, the array 122 can identify lock requests received out-of-sequence-order within the array 122 by using the sequence number of a request as an index into the array 122. For example, as shown, a lock request arrives identifying sequence domain “1” and a sequence number “6” allocated by the sequence circuitry 106 (FIG. 9A) to the requesting thread. The reorder circuitry 110 can use the sequence number of the request to store an identification of the received request within the corresponding entry of array 122 (e.g., sequence number 6 is stored in the sixth array entry). The entry may also store a pointer or reference to data included in the request (e.g., the requesting thread/core and options). As shown, a particular lock can be identified in a lock request by a number or other identifier. For example, if read data is associated with the lock, the number may represent a RAM (Random Access Memory) address. If there is no read data associated with the lock, the value represents an arbitrary lock identifier.

As shown, the array 122 can be processed as a ring queue. That is, after processing entry 122n the next entry in the ring is entry 122a. The contents of the ring are tracked by a “head” pointer which identifies the next lock request to be serviced in the sequence. For example, as shown, the head pointer 124 indicates that the next request in the sequence is entry “2.” In other words, already pending requests for sequence numbers 3, 4, and 6 must wait for servicing until a lock request arrives for sequence number 2.

As shown, each entry also has a “valid” flag. As entries are “popped” from the array 122 in sequence, the entries are “erased” by setting the “valid” flag to “invalid”. Each entry also has a “skip” flag. This enables threads to release a previously allocated sequence number, for example, when a thread chooses to drop a packet before entry into a critical section.

In operation, the reorder circuitry 110 waits for the arrival of the next lock request in the sequence. For example, in FIG. 9B, the circuitry awaits arrival of a lock request allocated sequence number “2”. Once this “head-of-line” request arrives, the reorder circuitry 110 can dispatch not only the head-of-line request that arrived, but any other pending requests freed by the arrival. That is, the reorder circuitry can sequentially proceed down the array 122, incrementing the “head” pointer through the ring, request by request, until reaching an “invalid” entry. In other words, as soon as the request arrives for sequence number “2,” the pending requests stored in entries “3”, “5” and “6” can also be dispatched to the lock circuitry 112. Basically, these requests arrived from threads that ran fast and requested the lock earlier than the next thread in the sequence. The “skip”-ed entry, “4”, permits the reorder circuitry to service entries “5” and “6” without delay. Once the reorder circuitry 110 reaches the first “invalid” entry, the domain sequence is, again, stalled until the next expected request in the sequence arrives.

FIG. 9C illustrates lock circuitry 112 logic. As shown and described above, the lock circuitry 112 receives lock requests from the reorder block 110 (e.g., either a non-sequenced request or the next in-order sequence request to reach the head-of-line of a sequence domain). The lock circuitry 112 maintains a table 130 of active locks and queues pending requests for these locks. As new requests arrive at the lock circuitry 112, the lock circuitry 112 allocates entries within the table 130 for newly activated locks (e.g., requests for locks not already in table 130) and enqueues requests for already active locks. For example, as shown in FIG. 9C, lock 241 130n has an associated linked list queuing two pending lock requests 132b, 132c. As the lock circuitry receives unlock requests, the lock circuitry 112 grants the lock to the next queued request and removes the entry from the queue. When an unlock request is received for a lock that does not have any pending requests, the lock can be removed from the active list 130. As an example, as shown in FIG. 9C, in response to an unlock request 134 releasing a lock previously granted for lock 241, the lock circuitry 110 can send a lock grant 138 to the core/thread that issued request 132b and advance request 132c to the head of the queue for lock 241.

Potentially, a thread may issue a non-blocking request (e.g., a request that is either granted or denied immediately). For such requests, the lock circuitry 110 can determine whether to grant the lock by performing a lookup for the lock in the lookup table 130. If no active entry exists for the lock, the lock may be immediately granted and a corresponding entry made into table 130, otherwise the lock may be denied without queuing the request. Alternately, if a non-blocking lock specifies a sequence number, the non-blocking lock request can be denied or granted when the non-blocking request reaches the head of its reorder array.

As described above, a given request may be a “read lock” request instead of a simple lock request. A read lock request instructs the lock manager 100 to deliver data associated with a lock in addition to granting the lock. To service read lock requests, the lock circuitry 110 can initiate a memory operation identifying the requesting core/thread as the memory operation target as a particular lock is granted. For example, as shown in FIG. 9C, read lock request 132b not only causes the circuitry to send data 138 granting the lock but also to initiate a read operation 136 that delivers requested data to the core/thread.

The logic shown in FIGS. 8 and 9A-9C is merely an example and a wide variety of other manager 106 architectures may be used that provide similar services. For example, instead of allocating and distributing sequence numbers, the sequence numbers can be assigned from other sources, for example, a given core executing a sequence number allocation program. Additionally, the content of a given request/reply may vary in different implementations.

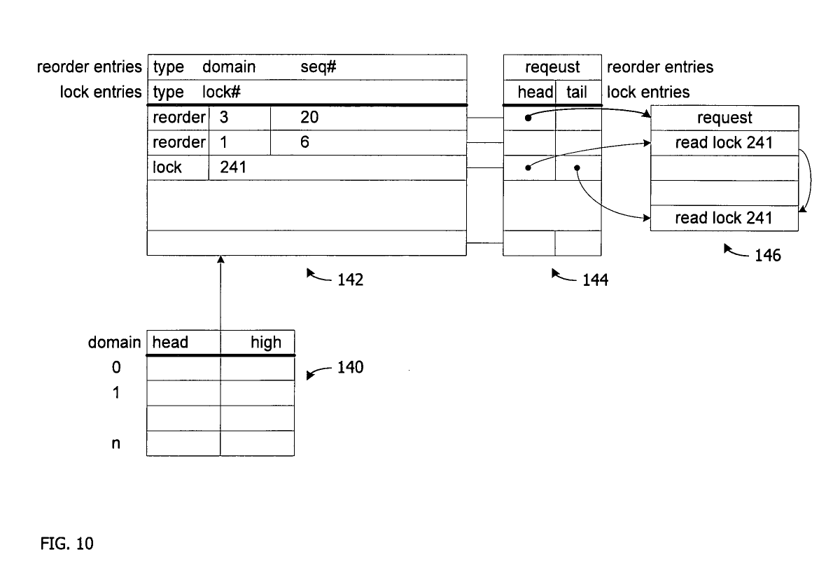

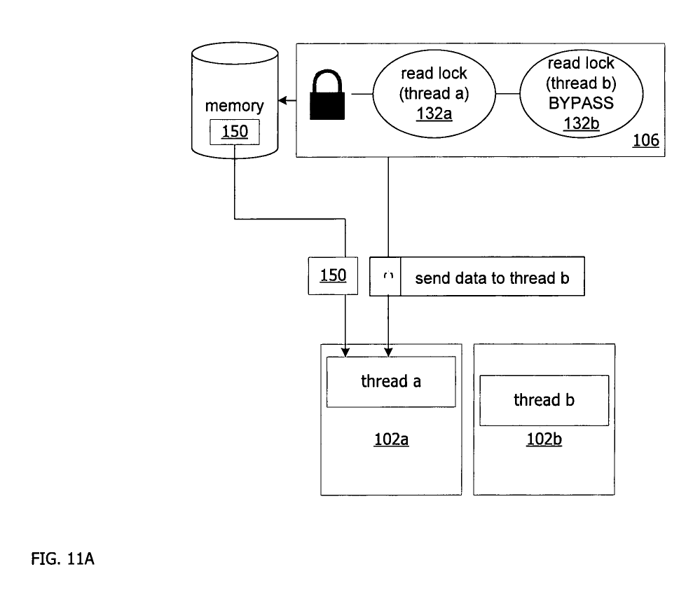

The logic shown in FIGS. 9B and 9C could be implemented in a wide variety of ways. For example, an implementation may use RAM (Random Access Memory) to store the N different reorder arrays and the lock tables. However, this storage will, typically, be sparsely populated. That is, a given reorder array may only store a few backlogged out-of-order entries at a time. Instead of allocating a comparatively large amount of RAM to handle worst-case usage scenarios, FIG. 10 depicts a sample implementation that features a single content addressable memory (CAM) 142. The CAM can be used to compactly store information in the reorder arrays (e.g., array 122 in FIG. 9B). That is, instead of storing empty entries in a sparse array (e.g., array 122), only “non-empty” reorder entries can be stored in CAM 142 (e.g., pending or skipped requests) at the cost of storing additional data identifying the domain/sequence number that would otherwise be implicitly identified by array 122. By “squeezing” the empties out, entries for all the reorder arrays can fit in the same CAM 142. For example, as shown, the CAM 142 stores a reorder entry for domain “3” and domain “1”. A memory 144 (e.g., a RAM) stores a reference for corresponding CAM reorder entries that identifies the location of the actual lock request data (e.g., requesting thread/core) in memory 146. Thus, in the event of a CAM hit (e.g., a CAM search for domain “3”, seq #“20” succeeds), the index of the matching CAM entry is used as an index into memory 144 which, in turn, includes a pointer to the associated request in memory 146. In this implementation instead of an “invalid” flag, “invalid” entries are simply not stored in the CAM, resulting in a CAM-miss when searched for by the CAM 142. Thus, the CAM 142 effectively provides the functionality of multiple reorder arrays without consuming as much memory/die-space.

In addition to storing reorder entries, the CAM 142 can also store the lock lookup table (e.g., 130 in FIG. 9C). As shown, to store the lock table 130 entries and the reorder array 122 entries in the same CAM 142, each entry in the CAM 142 is flagged as either a “reorder” entry or a “lock” entry. Again, this can reduce the amount of memory used by the lock manager 106. The queue associated with each lock is identified by memory 144 that holds corresponding head and tail pointers for the head and tail elements in a lock's linked list queue. Thus, when a given reorder entry reaches the head-of-line, adding the corresponding request to a lock's linked list is simply a matter of adjusting queue pointers in memory 146 and, potentially, the corresponding head and tail pointers in memory 144. Since the CAM 142 performs dual duties in this scheme, the implementation can alternate reorder and lock operations each cycle (e.g., on odd cycles the CAM 142 performs a search for a reorder entry while on even cycles the CAM 142 performs a search for a lock entry).

The implementation shown also features a memory 140 that stores the “head” (e.g., 124 in FIG. 9A) identifiers for each sequence domain. The head identifiers indicate the next sequenced request to be forwarded to the lock circuitry 112 for a given sequence domain. In addition, the memory 140 stores a “high” pointer that indicates the “highest” sequence number (e.g., most terminal in a sequence) received for a domain. Because the sequence numbers wrap, the “highest” sequence number may be a lower number than the “head” pointer (e.g., if the head pointer is less than the next expected sequence number).

When a sequenced lock request arrives, the domain identified in the request is used as an index into memory 140. If the requested sequence number does not match the “head” number (i.e., the sequence number of the request was not at the head-of-line), a CAM 142 reorder entry is allocated (e.g., by accessing a freelist) and written for the request identifying the domain and sequence number. The request data itself including the lock number, type of request, and other data (e.g., identification of the requesting core and/or thread) is stored in memory 146 and a pointer written into memory 144 corresponding to the allocated CAM 142 entry. Potentially, the “high” number for the sequence domain is altered if the request is at the end of the currently formed reorder sequence in CAM 142.

When a sequenced lock request matches the “head” number in table 140, the request represents the next request in the sequence to be serviced and the CAM 142 is searched for the identified lock entry. If no lock is found, a lock is written into the CAM 142 and the lock request is immediately granted. If the requested lock is found within the CAM 142 (e.g., another thread currently owns the lock), the request is appended to the lock's linked list by writing the request into memory 146 and adjusting the various pointers.

As described above, arrival of a request may free previously received out-of-order requests in the sequence. Thus, the circuitry increments the “head” for the domain and performs a CAM 142 search for the next number in the sequence domain. If a hit occurs, the process described above repeats for the queued request. The process repeats for each in-order pending sequence request yielding a CAM 142 hit until a CAM 142 miss results. To avoid the final CAM 142 miss, however, the implementation may not perform a CAM 142 search if the “head” pointer has incremented passed the “high” pointer. This will occur for the very common case when locks are being requested in sequence order, thereby improving performance (e.g., only one CAM 142 lookup will be tried because high value is equal to head value, not two with the second one missing, which would be needed without the “high” value).

The implementation also handles other lock manager operations described above. For example, when the circuitry receives a “sequence number release” request to return an allocated sequence number without executing the corresponding critical section, the implementation can write a “skip” flag into the CAM entry for the domain/sequence number. Similarly, when the circuitry receives a non-blocking request the circuitry can perform a simple lock search of CAM 142. Likewise, when the circuitry receives a non-sequenced request, the circuitry can allocate a lock and/or add the request to a link list queue for the lock.

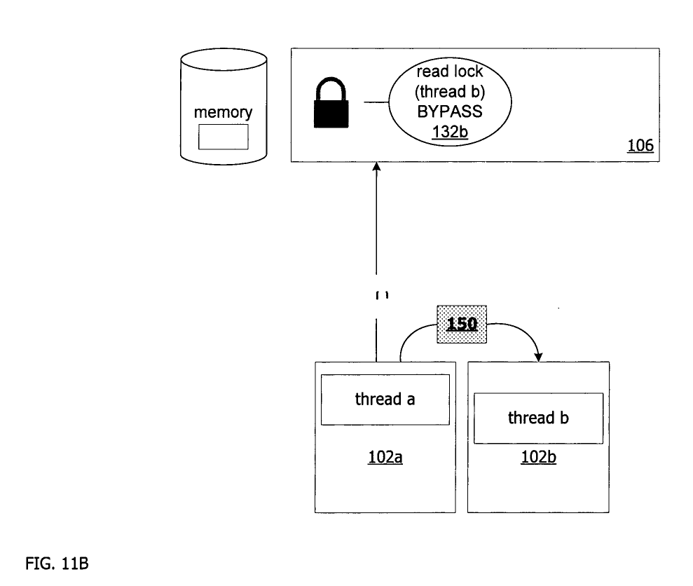

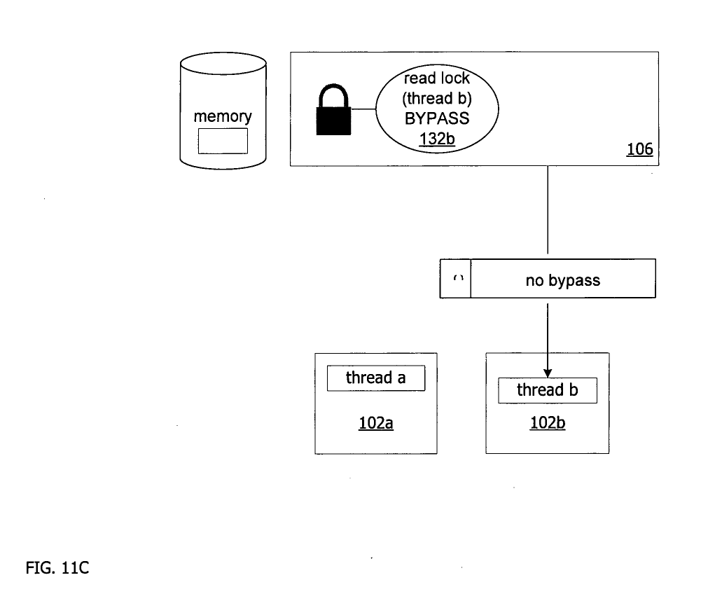

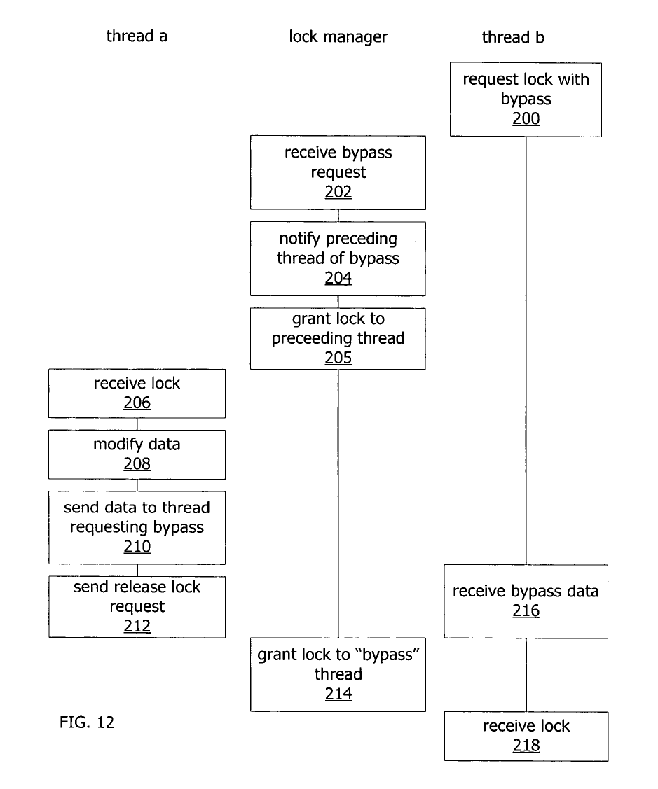

Typically, after acquiring a lock, a thread entering a critical section performs a memory read to obtain data protected by the lock. The data may be stored off-chip in external SRAM or DRAM, thereby, introducing potentially significant latency into reading/writing the data. After modification, the thread writes the shared data back to memory for another thread to access. As described above, in response to a read lock request, the lock manager 106 can initiate delivery of the data from memory to the thread on the thread's behalf, reducing the time it takes for the thread to obtain a copy of the data. FIGS. 11A-11B and 12 illustrate another technique to speed delivery of data to threads. In this scheme, instead of a thread writing modified data back to memory only to have another thread read the data from memory, the write-back to memory is bypassed in favor of delivery of the data from one thread to another thread waiting for the data. This technique can have considerable impact when a burst of packets belongs to the same flow.

To illustrate bypassing, FIG. 11A depicts a lock queue that features two pending lock requests 132a, 132b. As shown, the lock manager 106 services the first read-lock request 132a from thread “a” by initiating a read operation for lock protected data 150 on the thread's behalf and sending data granting the lock to thread “a”. In addition, because the following queued request 132b for thread “b” specified the data “bypass” option, the lock manager 106 sends a notification message to thread “a” indicating that the lock protected data should be sent to thread “b” of core 102b after modification. The message notifying thread “a” of the upcoming bypass operation can be sent as soon as the read lock bypass request is received by the lock manager 106.

As shown in FIG. 11B, before releasing the lock, thread “a” sends the (potentially modified) data 150 to thread “b”. For example, the thread “a” may use an instruction that permits inter-core communication <cache-cache direct copy>. Alternately, for data being passed between threads being executed by the same core, the data can be written directly into local core memory. After initiating the transfer of data, thread “a” can release the lock. As shown, in FIG. 11C, the lock manager 106 then grants the lock to thread “b”. Since no queued bypass request follows thread “b”, the lock manager can send the thread “Null” bypass information that thread “b” can use to determine that any modified data should be written back to memory instead of being passed to a next thread.

Potentially, bypassing may be limited to scenarios when there are at least two pending requests in a lock's queue to avoid a potential race condition. For example, in FIG. 11C, if a read lock request specifying the bypass option arrived after thread “b” obtained the lock, thread “b” may have already written the data to memory before new bypass information arrived from the lock manager. Of course, even in such a situation the thread can both write the data to memory and write the data directly to the thread requesting the bypass.

FIG. 12 depicts a flow diagram illustrating operation of the bypass logic. As shown, a thread “b” makes a read lock request 200 specifying the bypass option. After receiving the request 202, the lock manager may notify 204 thread “a” that thread “b” specified the bypass option and identify the location in thread “b”s core to write the lock protected data. The lock manager may also grant 205 the lock in response to a previously queued request from thread “a”.

After receiving the lock grant 206 and modifying lock protected data 208, thread “a” can send 210 the modified data directly to thread “b” without necessarily writing the data to shared memory. After sending the data, thread “a” releases the lock 212 after which the manager grants the lock to thread “b” 214. Thread “b” receives the lock 218 having potentially already received 216 the lock protected data and can immediately begin critical section execution. Thus, thread “b”, upon receiving the lock, already has the needed data.

Threads may use the lock manager 106 to implement work passing in a wide variety of ways. For example, the threads may use two different sequence domains: a packet processing domain and a work passing domain. In response to receipt of a packet, a sequence number in requested in both domains. The packet processing domain ensures that packets are processed in order of receipt while the work passing domain ensures that passed packets are passed in the order of receipt.

In operation, when a thread attempts to acquire a lock by submitting a non-blocking lock request with the sequence number, the request is enqueued if the request specifies a sequence number not yet at the head of the sequence domain reorder array. When the non-blocking request eventually reaches the top of the sequence domain queue, the request can either be granted or denied based on the state of the lock at that time. In either event, the packet processing sequence domain queue advances.

If a thread's lock request is denied, the thread can pass work to the thread that owns the lock for the flow. In this implementation, the thread submits a lock request for the work passing queue that identifies the allocated work passing sequence number associated with the packet. When this request reaches the top of the queue, the thread acquires the lock and may enqueue a packet to the lock owning thread's queue. Potentially, however, the thread may wait until previously received packets are passed.

Again, many variations of the above may be implemented. For example, instead of a single packet processing domain and work passing domain, an implementation may feature a packet processing domain and work passing domain for a single flow or a group of flows mapped to particular domains.

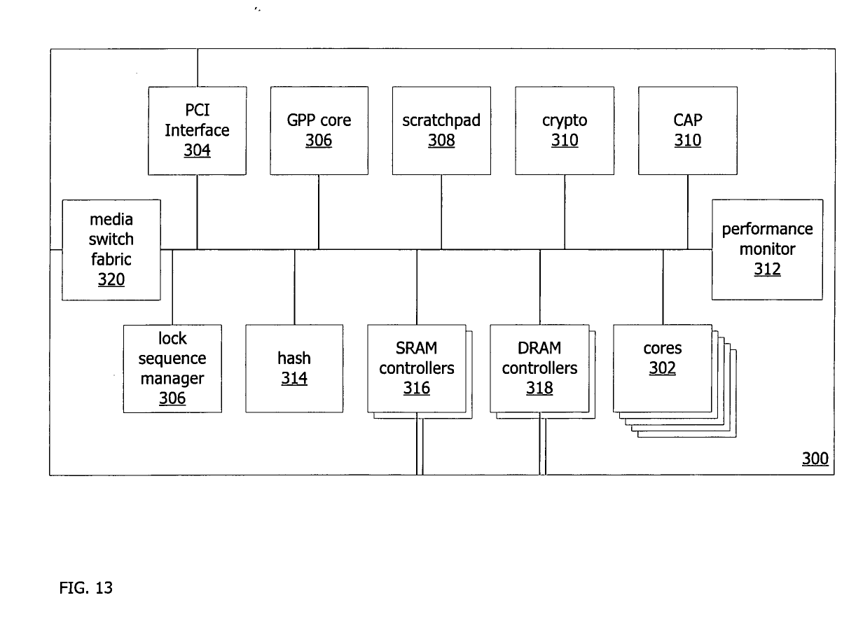

The techniques described above can be implemented in a variety of ways and in different environments. For example, the techniques may be implemented on processors having different architectures. For example, threads of a general purpose (e.g., Intel Architecture (IA)) processor may use the work passing techniques above. Additionally, the techniques may be used in more specialized processors such as a network processor. As an example, FIG. 13 depicts an example of network processor 300 that can be programmed to process packets. The network processor 300 shown is an Intel® Internet eXchange network Processor (IXP). Other processors feature different designs.

In this example, the network processor 300 is shown as featuring lock manager hardware 306 and a collection of programmable processing cores 302 (e.g., programmable units) on a single integrated semiconductor die. Each core 302 may be a Reduced Instruction Set Computer (RISC) processor tailored for packet processing. For example, the cores 302 may not provide floating point or integer division instructions commonly provided by the instruction sets of general purpose processors. Individual cores 302 may provide multiple threads of execution. For example, a core 302 may store multiple program counters and other context data for different threads.

As shown, the network processor 300 also features an interface 320 that can carry packets between the processor 300 and other network components. For example, the processor 300 can feature a switch fabric interface 320 (e.g., a Common Switch Interface (CSIX)) that enables the processor 300 to transmit a packet to other processor(s) or circuitry connected to a switch fabric. The processor 300 can also feature an interface 320 (e.g., a System Packet Interface (SPI) interface) that enables the processor 300 to communicate with physical layer (PHY) and/or link layer devices (e.g., Media Access Controller (MAC) or framer devices). The processor 300 may also include an interface 304 (e.g., a Peripheral Component Interconnect (PCI) bus interface) for communicating, for example, with a host or other network processors.

As shown, the processor 300 includes other components shared by the cores 302 such as a cryptography core 310 that aids in cryptographic operations, internal scratchpad memory 308 shared by the cores 302, and memory controllers 316, 318 that provide access to external memory shared by the cores 302. The network processor 300 also includes a general purpose processor 306 (e.g., a StrongARM® XScale® or Intel Architecture core) that is often programmed to perform “control plane” or “slow path” tasks involved in network operations while the cores 302 are often programmed to perform “data plane” or “fast path” tasks.

The cores 302 may communicate with other cores 302 via the shared resources (e.g., by writing data to external memory or the scratchpad 308). The cores 302 may also intercommunicate via neighbor registers directly wired to adjacent core(s) 302. The cores 302 may also communicate via a CAP (CSR (Control Status Register) Access Proxy) 310 unit that routes data between cores 302.

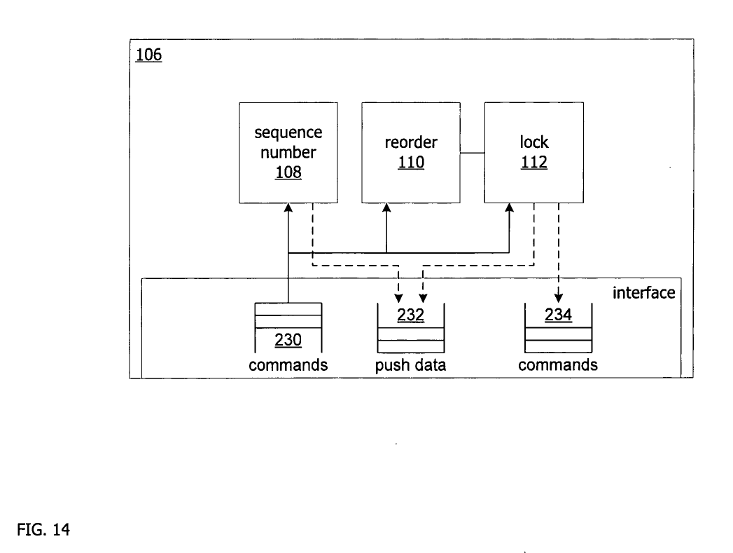

The different components may be coupled by a command bus that moves commands between components and a push/pull bus that moves data on behalf of the components into/from identified targets (e.g., the transfer register of a particular core or a memory controller queue). FIG. 14 depicts a lock manager 106 interface to these buses. For example, commands being sent to the manager 106 can be sent by a command bus arbiter to a command queue 230 based on a request from a core 302. Similarly, commands (e.g., memory reads for read-lock commands) may be sent from the lock manager from command queue 234. The lock manager 106 can send data (e.g., granting a lock, sending bypass information, and/or identifying an allocated sequence number) via a queue 232 coupled to a push or pull bus interconnecting processor components.

The manager 106 can process a variety of commands including those that identify operations described above, namely, a sequence number request, a sequenced lock request, a sequenced read-lock request, a non-sequenced lock request, a non-blocking lock request, a lock release request, and an unlock request. A sample implementation is shown in Appendix A. The listed core instructions cause a core to issue a corresponding command to the manager 106.

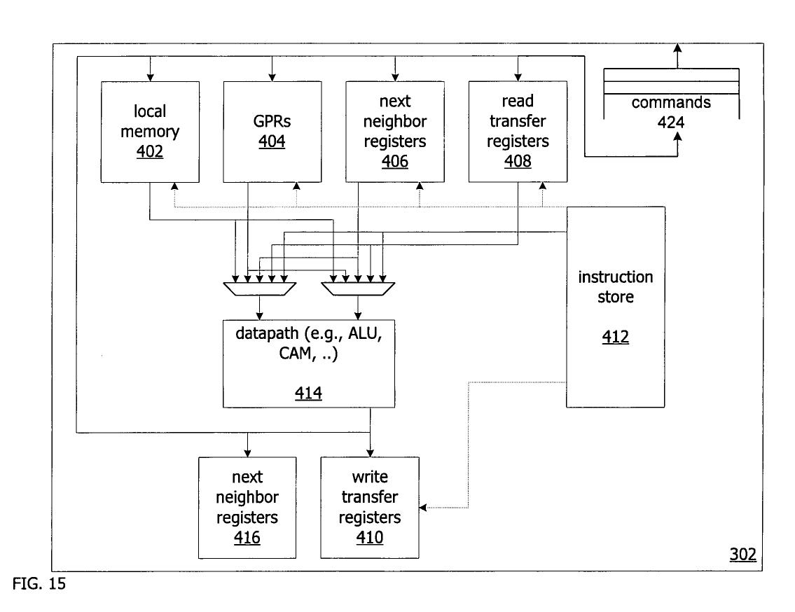

FIG. 15 depicts a sample core 302 in greater detail. As shown the core 302 includes an instruction store 412 to store programming instructions processed by a datapath 414. The datapath 414 may include an ALU (Arithmetic Logic Unit), Content Addressable Memory (CAM), shifter, and/or other hardware to perform other operations. The core 302 includes a variety of memory resources such as local memory 402 and general purpose registers 404. The core 302 shown also includes read and write transfer registers 408, 410 that store information being sent to/received from components external to the core and next neighbor registers 406, 416 that store information being directly sent to/received from other cores 302. The data stored in the different memory resources may be used as operands in the instructions and may also hold the results of datapath instruction processing. As shown, the core 302 also includes a command queue 424 that buffers commands (e.g., memory access commands) being sent to targets external to the core.

To interact with the lock manager 106, threads executing on the core 302 may send lock manager commands via the command queue 424. These commands may identify transfer registers within the core 302 as the destination for command results (e.g., an allocated sequence number, data read for a read-lock, release success, count, thread/core currently owning the thread, and so forth). In addition, the core 302 may feature an instruction set to reduce idle core cycles. For example, the core 302 may provide a ctx_arb (context arbitration) instruction that enables a thread to swap out/stall thread execution until receiving a signal associated with some operation (e.g., granting of a lock or receipt of a sequence number).

A program thread executed by the core can implement the work passing scheme described above. In particular, a thread that obtains a critical section/shared memory lock can maintain the associated shared memory in local core storage (e.g., 402, 404) across the processing of different work items (i.e., packets). Coherence can be maintained by writing the locally stored data back to SRAM/DRAM upon exiting the critical section. Again, saving the shared data in local storage across multiple packets can avoid multiple memory accesses to read and write the shared data to memory external to the core.

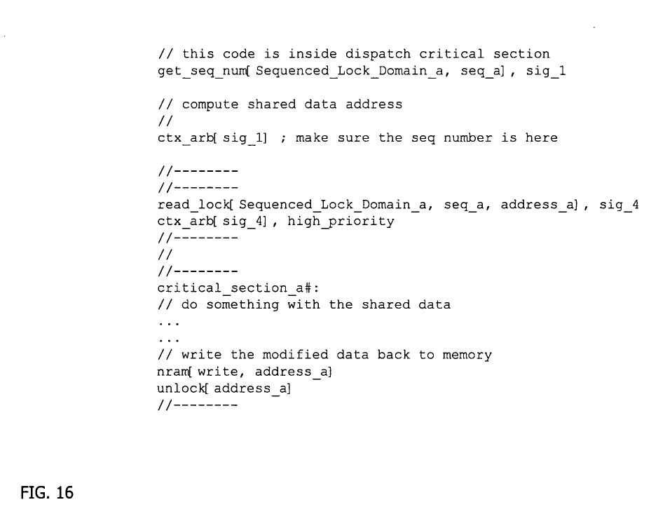

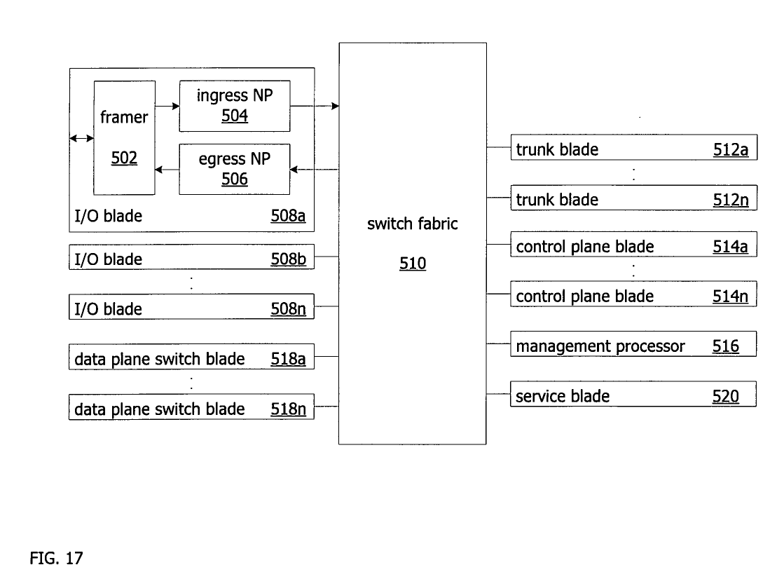

FIG. 16 illustrates an example of source code of a thread using lock manager services. As shown, the thread first acquires a sequence number (“get_seq_num”) and associates a signal (sig_1) that is set when the sequence number have been written to the executing thread's core transfer registers. The thread then swaps out (“ctx_arb”) until the sequence number signal (sig_1) is set. The thread then issues a read-lock request to the lock manager 106 and specifies a signal to be set when the lock is granted and again swaps out. After obtaining the grant, the thread can resume execution and can execute the critical section code. Finally, before returning the lock (“unlock”), the thread writes data back to memory.

FIG. 17 depicts a network device that can process packets using thread work passing described above. As shown, the device features a collection of blades 508-520 holding integrated circuitry interconnected by a switch fabric 510 (e.g., a crossbar or shared memory switch fabric). As shown the device features a variety of blades performing different operations such as I/O blades 508a-508n, data plane switch blades 518a-518b, trunk blades 512a-512b, control plane blades 514a-514n, and service blades. The switch fabric, for example, may conform to CSIX or other fabric technologies such as HyperTransport, Infiniband, PCI, Packet-Over-SONET, RapidIO, and/or UTOPIA (Universal Test and Operations PHY Interface for ATM).

Individual blades (e.g., 508a) may include one or more physical layer (PHY) devices (not shown) (e.g., optic, wire, and wireless PHYs) that handle communication over network connections. The line cards 508-520 may also include framer devices (e.g., Ethernet, Synchronous Optic Network (SONET), High-Level Data Link (HDLC) framers or other “layer 2” devices) 502 that can perform operations on frames such as error detection and/or correction. The blades 508a shown may also include one or more network processors 504, 506 that perform packet processing operations for packets received via the PHY(s) 502 and direct the packets, via the switch fabric 510, to a blade providing an egress interface to forward the packet. Potentially, the network processor(s) 506 may perform “layer 2” duties instead of the framer devices 502. The network processors 504, 506 may feature lock managers implementing techniques described above.

Again, while FIGS. 13-17 described specific examples of a network processor and a device incorporating network processors, the techniques may be implemented in a variety of architectures including processors and devices having designs other than those shown. Additionally, the techniques may be used in a wide variety of network devices (e.g., a router, switch, bridge, hub, traffic generator, and so forth). Accordingly, implementations of the work passing techniques described above may vary based on processor/device architecture.

The term circuitry as used herein includes hardwired circuitry, digital circuitry, analog circuitry, and so forth. Techniques described above may be implemented in computer programs that cause a processor (e.g., a core 302) to use a lock manager as described above.

Other embodiments are within the scope of the following claims.

What is claimed is:

1. A method, comprising:
at a first thread of a set of threads provided by a processor comprising multiple multi-threaded processing units integrated in a single die:
receiving identification of a network packet;
issuing a request for a lock;
if the lock is granted:
performing at least one operation for the network packet;
determining if another thread has passed identification of a second network packet belonging to the same flow as the first thread to the first thread;
performing at least one operation for the network packet; and
if the lock is not granted:
determining a thread owning the lock; and
passing identification of the network packet to the determined thread owning the lock.

2. The method of claim 1,
wherein the determining if another thread has passed identification of the second network packet comprises:
issuing a request to unlock the lock; and
in response to issuing the request, receiving an indication that at least one other thread attempted to acquire the lock.

3. The method of claim 2,
wherein the receiving the indication comprises a count of at least one thread attempting to acquire the lock.

4. The method of claim 1,
wherein the determining the thread owning the lock comprises receiving a response to the request for the lock data identifying the thread owning the lock.

5. A processor, comprising:
multiple multi-threaded processing units integrated on a single die;
circuitry coupled to the multiple multi-threaded processing units integrated on the single die, the circuitry to:
receive lock requests from threads executing on the multiple multi-threaded processing units;
respond to lock requests with an identification of a thread currently owning the lock if the requested lock owned by a thread;
receive requests to release locks from threads executing on the multiple multi-threaded processing units; and
respond to the request to release locks based on requests for the lock received while the lock is owned by a thread.

6. The processor of claim 5,
wherein the circuitry increments a lock counter based on a lock request for a lock owned by another thread.

7. The processor of claim 6,
wherein the circuitry to respond to the request to release locks comprises circuitry to respond to the request with an unlock denial based on the lock counter.

8. The processor of claim 6, wherein the circuitry to respond to the request to release locks comprises circuitry to respond with the lock counter's value.

9. A computer program product, disposed on a computer readable medium, the product comprising instructions for causing a processing having multiple multi-threaded processing units integrated in a single die to:
at a first thread of a set of threads provided by the:
receiving identification of a network packet;
issuing a request for a lock;
if the lock is granted:
performing at least one operation for the network packet;
determining if another thread has passed identification of a second network packet belonging to the same flow as the first thread to the first thread;
performing at least one operation for the network packet; and
if the lock is not granted:
determining a thread owning the lock; and
passing identification of the network packet to the determined thread owning the lock.

10. The program of claim 9,
wherein the determining if another thread has passed identification of the second network packet comprises:
issuing a request to unlock the lock; and
in response to issuing the request, receiving an indication that at least one other thread attempted to acquire the lock.

11. The program of claim 10,
wherein the receiving the indication comprises a count of at least one thread attempting to acquire the lock.

12. The program of claim 9,
wherein the determining the thread owning the lock comprises receiving a response to the request for the lock data identifying the thread owning the lock.

13. A method, comprising:
assigning a work item to a first of multiple peer threads provided by a multi-threaded processor, the work item being part of a flow of work items; and
reassigning, by the first of the multiple peer threads, the work item to a different one of the multiple peer threads.

14. The method of claim 13,
wherein the reassigning comprises enqueueing the work item to the different one of the multiple peer threads.

15. The method of claim 13, wherein the work item comprises a network packet.

16. The method of claim 13, further comprising:
determining whether to perform the reassigning based on at least one work load metric.

17. The method of claim 13, further comprising reassigning each of multiple work items belonging to the same work flow to the different one of the multiple peer threads.
